(19) United States
(12) Patent Application Publication
(10) Pub. No.: US 2026/0014725 A1
(43) Pub. Date: Jan. 15, 2026

(54) SHEET METAL INSULATION TEMPLATE

(71) Applicant: Anthony Farin, Whitman, MA (US)

(72) Inventor: Anthony Farin, Whitman, MA (US)

(21) Appl. No.: 19/274,204

(22) Filed: Jul. 18, 2025

Related U.S. Application Data
(60) Provisional application No. 63/671,420, filed on Jul. 15, 2024.

(51) Int. Cl. B26B 29/06; F24F 13/02

(52) U.S. Cl. CPC B26B 29/06; F24F 13/0245

(57) ABSTRACT

A sheet metal insulation template includes a sheet of metal including one or more slots patterned across the sheet of metal, also including a fold formed in the sheet of metal to facilitate compact storage. The one or more slots are mirrored across the fold in the sheet metal. The method of use includes obtaining insulation template and laying it on a piece of insulation. The user selects the one or more slots corresponding to a particular size of the elbow pipe and inserts a cutting device in the selected slots to cut the piece of insulation. When done, the user removes the cutting device and the insulation template and forms the cut piece of insulation around the elbow pipe.

### CROSS REFERENCE TO RELATED APPLICATIONS

This application claims the benefit of an earlier filing date and right of priority to U.S. Provisional Application No. 63/671,420, filed 15 Jul. 2024, the contents of which is incorporated by reference herein in its entirety.

### BACKGROUND OF THE INVENTION

### 1. Field of the Invention

The present application relates to insulating duct work, and more particularly to a template for streamlining the process of insulating mechanical fittings.

### 2. Description of Related Art

Throughout history, the pursuit of regulating indoor temperatures and preserving energy has driven innovation in insulation techniques. Early civilizations employed natural materials like animal skins, mud, and wood to create rudimentary barriers against heat loss. The ancient Greeks and Romans further advanced insulation methods, using materials such as cork and asbestos in building construction. However, it wasn't until the Industrial Revolution that modern insulation materials like fiberglass, mineral wool, and foam board began to emerge, revolutionizing the way we manage thermal energy in buildings.

In the 20th century, with the advent of central heating and air conditioning systems, insulation became a critical component of building design. Innovations in manufacturing processes led to the development of more efficient and versatile insulation materials, enabling architects and engineers to create structures with enhanced energy efficiency. Today, insulation plays a vital role in mitigating heat loss and reducing energy consumption in residential, commercial, and industrial buildings, driving sustainability efforts and contributing to environmental conservation.

In the realm of HVAC (Heating, Ventilation, and Air Conditioning) systems, insulating sheet metal elbows poses a persistent challenge for technicians and installers alike. These 90-degree radius elbows, essential components in ductwork, require precise and efficient insulation to maintain thermal efficiency and prevent energy loss. However, the process of measuring, cutting, and fitting insulation around these elbows is labor-intensive and time-consuming, often resulting in inaccuracies and wasted materials. Additionally, the complexity of insulating sheet metal elbows can lead to subpar installations, compromising energy efficiency and potentially causing system inefficiencies or failures. This presents a significant obstacle in HVAC projects, where time, labor, and material costs are crucial considerations.

The current methods for insulating sheet metal elbows lack standardization and efficiency, leading to inconsistencies in insulation quality and installation time. Technicians must resort to manual measurements and cutting, increasing the likelihood of errors and rework. Moreover, the intricate nature of these elbows makes it challenging to achieve a uniform and professional-looking insulation, impacting both aesthetics and functionality. As a result, there is a pressing need for an innovative solution that streamlines the process of insulating sheet metal elbows, reducing labor time, minimizing material waste, and ensuring consistent and effective insulation across HVAC systems. Although strides have been made, shortcomings remain.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a top perspective view of a sheet metal insulation template according to an embodiment of the present application.

FIGS. 2-3 is a second top view of the template of FIG. 1, wherein the template is folded.

FIG. 4 is a perspective view of a piece of insulation cut to fit a pipe using the template of FIG. 1.

FIG. 5 is a chart of the method of use of the sheet metal insulation template of FIGS. 1-4.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The Sheet Metal Insulation Template of the present application is a groundbreaking solution designed to revolutionize the insulation process for HVAC sheet metal elbows. This innovative product provides technicians and installers with a precise and efficient tool for cutting insulation material to exact dimensions, significantly reducing labor time and improving installation accuracy. The template consists of a flat sheet with strategically placed color-coded slots, allowing users to effortlessly trim insulation material to fit 90-degree radius elbows of varying sizes, ranging from 4 inches up to 16 inches and potentially larger. The slots serve as guides for cutting or marking insulation material, ensuring precise and uniform results with minimal effort.

By utilizing the Sheet Metal Insulation Template, technicians can streamline the insulation process, eliminating the need for manual measurements and guesswork. The color-coded slots not only enhance cutting accuracy but also prevent errors and miss-cuts, resulting in professional-looking insulation jobs that enhance the thermal efficiency of HVAC systems. Furthermore, the template's durable construction ensures longevity and resistance to accidental cutting, providing a reliable and cost-effective solution for insulating sheet metal elbows. Overall, the Sheet Metal Insulation Template addresses the persistent challenges faced in HVAC projects, offering a practical and efficient tool that maximizes productivity, minimizes material waste, and ensures consistent insulation quality across installations.

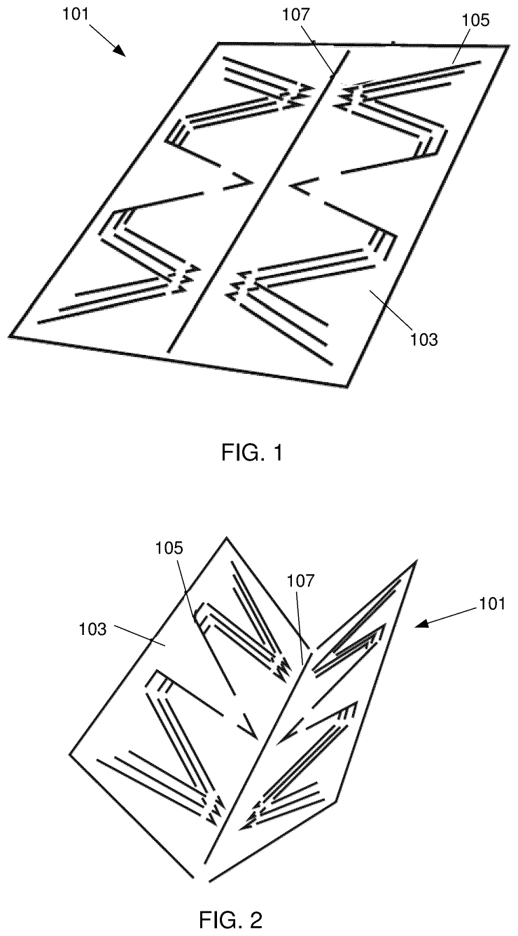

Referring now to FIGS. 1-3 in the drawings, views of sheet metal insulation template 101. Template 101 is a fabricated metal sheet 103 made from high-grade material. It serves as a foundation for cutting insulation material to precise dimensions for use with HVAC sheet metal elbow fittings. Template 101 includes one or more slots 105. Slots 105 are patterned across an upper surface of sheet 103 where in the pattern is shaped to accommodate a curved metal elbow fitting. It is understood that one or more slots 105 are illustrated where in each slot pattern is used for a different sized metal elbow fitting. It is understood that slots 105 maybe strategically color-coded so as to act as a guide for cutting or marking insulation material. The color coding ensures accuracy and consistency in the installation process. Each color may correspond to specific dimensions or diameters of pipe thereby enhancing ease of use and reducing the risk of errors.

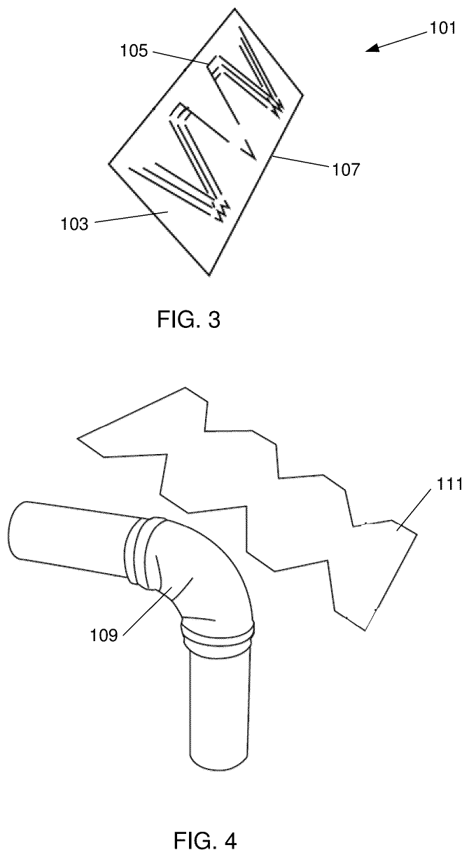

Sheet 103 has a central fold 107 which acts as a hinged design allowing it to fold easily for compact storage and transportation. Fold 107 enhances the tools portability and convenience enabling technicians to carry it to job sites without hassle. Fold 107 extends from between opposing sides of sheet 103 and may be stamped, perforated, or include other treatments to permit flexibility along its line. As seen in FIG. 2 specifically, sheet 103 is shown partially folded from that depicted in FIG. 1. In particular with FIG. 3, sheet 103 is shown fully folded along fold 107. In this orientation, a closed orientation, sheet 103 is most easily transported. The open configuration of FIG. 1 is ideal for when sheet 103 is to be used. Slots 105 are mirrored across fold 107.

It is understood that sheet 103 may be constructed from durable and resilient materials. Template 101 is built to a stand the rigors of HVAC installation work. Many different types of materials may be suitable such as composites, metals, or the like. It is desired that template 101 use materials that ensures longevity and resistance to accidental damage so as to provide reliable performance over time.

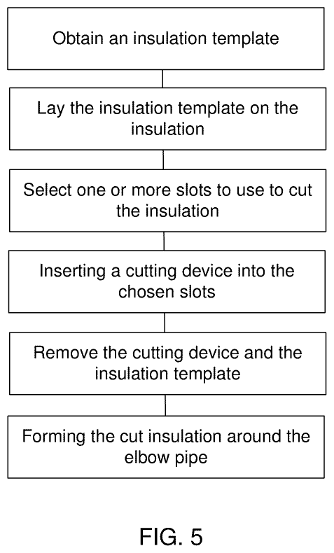

Referring now to FIGS. 4-5 in the drawings, elbow fitting 109 is shown along with insulation 111. Insulation 111 has been trimmed using template 101. In operation, a user lays template 101 over a piece of insulation 111. The user verifies the diameter of pipe and selects the appropriate slots 105 on template 101. Once selected the user cuts insulation 111 through the selected slot to generate insulation 111 shape. Template 101 is removed and the user handles insulation 111 and wraps it around elbow fitting 109.

It is understood that template 101 is described in particular use with a 90° elbow fitting 109. It is understood that template 101 may include one or more slot patterns that allow it to accommodate different angles of elbows along with different diameters of pipe.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An insulation template, comprising:
a sheet of metal including one or more slots patterned across the sheet of metal; and
a fold formed in the sheet of metal to facilitate compact storage;
wherein the one or more slots are mirrored across the fold in the sheet metal.

2. The template of claim 1, wherein the one or more slots are color coded.

3. The template of claim 2, wherein the colors correspond to a particular size of elbow pipe.

4. The template of claim 1, wherein the fold is stamped.

5. The template of claim 1, wherein the fold is perforated.

6. The template of claim 1, wherein the sheet of metal may be folded along the fold between an open orientation and a closed orientation.

7. A method of forming insulation around an elbow pipe, comprising:
obtaining an insulation template according to claim 1;
laying the insulation template on a piece of insulation;
selecting the one or more slots corresponding to a particular size of the elbow pipe;
inserting a cutting device in the selected one or more slots to cut the piece of insulation;
removing the cutting device and the insulation template; and
forming the cut piece of insulation around the elbow pipe.

8. The template of claim 7, wherein the one or more slots are color coded.

9. The template of claim 7, wherein the fold is stamped.

10. The template of claim 7, wherein the fold is perforated.

11. The template of claim 7, wherein the sheet of metal may be folded along the fold between an open orientation and a closed orientation.
